(19) United States
(12) Patent Application Publication
(10) Pub. No.: US 2004/0066052 A1
(43) Pub. Date: Apr. 8, 2004

(54) Cargo storage system

(76) Inventor: Stephen John Payne, Harwich (GB)

Correspondence Address: Arne M Olson, Olson & Hierl, 36th Floor, 20 North Wacker Drive, Chicago, IL, 60606, US

(21) Appl. No.: 10/468,590

(22) PCT Filed: Feb. 20, 2001
(86) PCT No.: PCT/GB01/00712

(51) Int. Cl. B62D 33/00

(52) U.S. Cl. 296/32

(57) ABSTRACT

A cargo storage system (14), e.g. of a road freight semi-trailer (18) comprises a rectangular base (10) with telescopic support masts (12). The support masts (12), by means of height adjustment tables (82) and a rectangularly orientated support cable (70), are adapted to support a box-shaped flexible cover (50) in a raised position over the base (10). The support masts (12) may be retracted and/or the height adjustment cables (82) released to lower the cover (50) may engage against cargo loaded on the base (10). The cover includes a grid pattern of webbing straps integral therewith, which may be tensioned down so that the cover engages against and bears down upon the cargo to restrain the cargo in position. The cover (50) is removeable and foldable and the masts (12) removable for stowage thereof. The invention is also applicable to rigid vehicle, full trailer, intermodal and other freight applications.

The present invention relates to a cargo storage system and, in particular, to a system for restraining and/or covering a cargo load. The invention is particularly applicable within the freight industry where it has application in intermodal freight, rigid (e.g. rigid vehicle) semi-trailer and full trailer applications. The invention also relates to a method of storing cargo, and to a method of transporting cargo. The invention also relates to a cargo carrying vehicle, such as a road truck, railway truck, ship or aircraft.

In the freight industry, Tilt-trailers (such as of the semitrailer type) are known. Such a trailer comprises a metal or alloy framework, oblong in shape, covered by a plastic sheet. Steel rings, attached to the bottom edge of the sheet are fitted over D-shaped staples attached to doors of the trailer, and a continuous wire cord is passed through each staple to allow the trailer to be secured with a seal at one point, and this has historically been useful for customs purposes.

Tautliners (or Taut trailers) are also known in the freight industry and include a metal or alloy framework, oblong in shape, and consisting of a solid roof and headboard, opening rear doors, and side sheets which slide within a track attached to the roof. These side sheets are connected to a base of the trailer by means of clips fitted to straps which run vertically down the side sheets at intervals along the length of the trailer and are attached to the underside of the base of the trailer.

A Euroliner is a variation of a Tautliner, having a sliding or removable roof.

With the above known cargo storage systems, construction and maintenance costs are relatively high. Tilt-trailers and Tautliners cannot carry some types of cargo, particularly cargo which is heavy and requires vertical loading with a crane, due to their rigid construction. The Euroliner also has a rigid construction and increased downtime due to the number of moving parts, necessitating increased maintenance. The known cargo storage systems are relatively heavy and this, combined with the large surface area thereof, means that fuel consumption is not particularly good. Additionally, the top weight allowed for trucks on British roads is 40 tonnes and, therefore, it is not possible to carry loads over a particular weight.

Another problem with the prior art is that it is believed that at least 50% of freight loads are bulk raw materials, such as bulk steel or china clay. Such cargoes are dense and, when loaded on the known cargo storage systems, take up space at the bottom of the box-like framework thereof; a substantial part of the upper region of the framework therefore frequently runs empty. However, it is not possible to design the known cargo storage systems to be lower, because, when carrying light loads, such as palatised empty drinks containers, they need to be filled to the top to be as competitive as possible. This means that the known cargo storage systems are always relatively tall and the routes they can take, particularly on the continent of Europe, are highly restricted by low bridges. The tall structure means that aerodynamic drag/fuel consumption is always relatively high, whatever the nature of the cargo carried.

Another problem is that when a known cargo storage system is transported with cargo from a first location to a second location and then emptied, it is sometimes necessary to transport the cargo storage system back to the first location or another location empty, and this can be very expensive, particularly when it is necessary to make this journey at least partly by ship. An empty cargo storage system can cost as much to transport by ship as a full cargo storage system, even though a full cargo storage system can weigh considerably more.

According to a first aspect of the present invention there is provided a cargo storage system comprising a base for supporting cargo, storage means for storing cargo on the base, and a support structure for the storage means, the support structure being adapted to support the storage means in a raised position thereof above the base and to lower the storage means down from the raised position to a lowered position in which the storage means lies over the base. This has the advantage that cargo can be loaded on to the cargo storage system with the storage means in the raised position and the storage means may then be lowered to a position over or on the cargo on the base.

Therefore, when the storage means forms an exterior surface of the cargo storage system, fuel consumption may be improved by minimising the size of the exterior surface. It is also possible to pass under lower bridges with the storage means in the lowered position than with known cargo storage systems with a rigid framework. Additionally, the cargo storage system may be made lighter, more cheaply, and easier to maintain and manhandle.

Preferably, the base includes a generally flat, horizontal upper surface. In preferred embodiments, the base has a main body with a front edge, a rear edge and two side edges, and is preferably rectangular. The base may include a headboard, locatable at the front of the main body with a generally vertical and laterally extending surface thereof located across and above the front edge of the main body. The advantage of the headboard is that it may stop cargo from shifting off the front of the main body under high emergency or accidental deceleration conditions. The headboard, when fitted, may be removably or hingedly coupled to the main body and may hinge down to a position generally abutting against the horizontal upper surface for stowage thereof.

In some preferred embodiments, the base is approximately 13.8 metres long and approximately 2.55 metres wide.

The upper surface of the base may include a load well. Such a load well may be used for the transportation of rolls of steel and other cylindrical objects which may be placed in the load-well at least partly extending down therein to minimise the possibility of movement of the cargo during transport of the cargo storage system. Preferably, a removable lid for the well is provided, the lid being locatable with an upper surface thereof generally flush with the upper surface of the base of the cargo storage system.

The base may comprise a cargo platform, e.g. of a vehicle, such as a cargo platform of a freight trailer, for example, a semi-trailer, the semi-trailer having road wheels under the base and means for attachment to a tractor unit, such as a truck tractor cab. In the case of a semi-trailer, the semi-trailer may be pivotally attachable to a tractor unit by a fifth wheel coupling. Likewise, in the case of a semi-trailer, at least one landing leg may be provided in front of the road wheels.

Alternatively, the base may comprise a cargo platform of a railway vehicle.

In another embodiment, the base comprises an intermodal cargo base or platform, the intermodal cargo base or platform preferably being transferable between railway, road vehicles, and preferably other types or vehicles such as ships and aircraft and vice versa.

In this case, the base may include a generally flat bottom support surface, the flat bottom support surface being adapted to be supported on a flat support surface of a cargo area of a railway, road or other vehicle, such as a railway truck or a road freight semi-trailer, full trailer, or simply a rigid vehicle having the flat support surface rigidly attached to a tractor or cab unit thereof.

Preferably, in a stowed configuration of the cargo storage system, the base thereof may be stackable for transport or storage purposes, one on top of the other, with a plurality of similar systems. This has the substantial advantage that several such systems may be transported multi-stacked, e.g. on ships, at relatively low cost.

In preferred the embodiments, the storage means includes restraining means, the restraining means being adapted to engage the storage means against cargo located on the base and to be tensioned against and/or bear down upon the cargo to restrain movement of the cargo on the base.

Preferably, the restraining means comprises at least one elongate flexible member, such as web or strap, which is securable over cargo on the base.

Preferably, the storage means has a flexible membrane-like form and said form may be a reticulated or sheet-like form.

In preferred embodiments, the storage means has a sheet-like, preferably flexible, form and most preferably comprises a sheet of material, a tarpaulin or other sheet-like cover for covering cargo on the base. The advantage of a cover in the form of a sheet of material is that the effects of rain, wind, snow and other weather on any cargo carried by the cargo storage may be minimised, since the cover may substantially or fully seal with the base to form an enclosure for the cargo between the base and the storage means. The storage means may alternatively have a reticulated, preferably flexible, form comprising a network of retaining straps.

Preferably, the storage means includes restraining means integral with the cover. Preferably, the restraining means comprises at least one elongate flexible member, preferably a web or strap, formed integrally with the cover. Preferably, each flexible member is sewn and/or secured with adhesive or other fastening means to the cover. An advantage of this construction is that lightweight material may be employed for the cover and material with relatively high tensile strength properties, for the elongate flexible member. Therefore, overall, the storage means may be very light. In the prior art, sheets of material on Tilt-trailers, Tautliners and Euroliners have been very heavy, for example, 750 kg being typical for a 40 ton semi-trailer application. Heavyweight material is used since, sometimes, cargo, particularly palatised goods, is not roped down in place inside the prior art cargo storage systems and, if movement relative to the base thereof occurs, the material of the sheet is relied upon (sometimes unsuccessfully) to prevent the cargo from falling off the base, for example, on sharp corners at speed. However, the storage means in the present application is preferably less than 500 kg in weight, ideally less than 400 or 300 kg, 200 kg being one example for a 40 ton semi-trailer unit. The construction mentioned above, enables the sheet material employed to be particularly lightweight, since the at least one elongate flexible member, in preferred embodiments, load-bearing. The restraining means may include a lateral series of mutually spaced straps, each strap in the lateral series extending across the cover, in a raised configuration thereof, in a lateral direction.

The restraining means may include a longitudinal series of mutually spaced straps, each strap in the longitudinal series extending along the cover, in a raised configuration thereof, in a longitudinal direction.

In the raised configuration, the cover may include a flat top surface, preferably having substantially the same planform as the base, the top surface being square or rectangular and having two opposite side edges, a front edge and a rear edge.

In the raised configuration, the cover may include two side surfaces, the side surfaces extending down from the side edges of the flat top surface.

In the raised configuration, the cover may include a front surface and a rear surface, the front and rear surfaces extending down from the front and rear edges, respectively, of the flat top surface.

In the raised configuration, the cover and base may form a substantially enclosed box-form, with lower edges of at least the side surfaces preferably being located adjacent side edges of the base, and lower edges of the front and rear surfaces preferably being located adjacent front end rear edges, respectively, of the base.

In one embodiment, each strap includes a fastener thereon which is adapted to be secured to the base. Each strap may include a tensioner device located at at least one end thereof, the tensioner device preferably including a hook and the base preferably including a corresponding means such as a projecting ledge for mutual engagement therewith.

Most preferably, the storage means is of flexible and/or foldable material. The advantage of this is that the storage means may be relatively easily manhandled and/or folded up for stowage.

The storage means may comprise a cover for the cargo. The cover may comprise a sheet of material and in one configuration preferably has a flat top surface and at least one side surface extending down from an edge of the top surface, and a series of fastener attachment means located on the side surface at a plurality of different distances below the top surface. Preferably, the fastener attachment means are located on vertically extending webs integral with the side surface. The side surface may include a series of horizontally extending webs forming a grid pattern with the vertically extending webs. The fastener attachment means are preferably located on said webs and at least some of the fastener attachment means may be located at nodes of the grid pattern on the side surface. The fastener attachment means may comprise rings or hooks and may be adapted to be engaged by hooks or rings of a securement means of a base of the cargo storage system. The cover may include four said side surfaces and in the said one configuration may form the top and four sides of a square or oblong box-shaped structure. The webs, in the said one configuration, are preferably located on the exterior of the sheet of material. The webs may be sewn and/or attached by adhesive to the sheet of material. An upper portion of the sheet of material may be protected by a fly sheet sewn or attached by adhesive or other fastening means thereto, on the exterior side of the sheet of material, with the webs being located between the sheet of material and the fly sheet.

In one embodiment each web (or strap) includes a series of mutually spaced fasteners thereon, the fasteners comprising rings fastened to the web at mutually spaced intervals along the length thereof. The base may include a series of hooks, each web having one ring thereof engaged by one said hook, each hook being secured to the base, for example, by a cord, the cord, for example, being tensionable by a ratchet wheel located on the base for tensioning the cover.

The base preferably includes a locker and, preferably, the storage means, may be folded and placed in the locker for stowage.

To provide sufficient strength with reduced weight, the cover may incorporate kevlar material. A problem with current sheet materials on cargo storage systems is that access to the cargo may easily be obtained therethrough with a knife for the purposes of burglary. It is believed that the use of kevlar yarn in the sheet material of the cover may substantially improve the resistance of the cover to such knife attacks.

Preferably, the support structure includes at least one mast which, in one configuration of the system, is located on the base with one end thereof higher than the base, the mast in the said one configuration preferably being in a generally vertical orientation.

The mast may be removably or pivotally mounted on the base and may include a projection or recess at a lower end thereof which is engageable with a corresponding recess or projection of the base for holding the mast in the generally vertical orientation. The mast may be pivotally mounted, at a lower end thereof, to the base, and may be adapted to pivot down from the generally vertical orientation thereof to a stowage position, preferably in which the mast is orientated generally horizontally.

In a preferred embodiment, the mast is extendable and retractable in length. Preferably, the mast is telescopically extendable and retractable in length. The mast, in an extended configuration thereof, may be about 2.7 metres long. The mast, in a retracted configuration thereof may be about 5 ft (about 1.5 metres) long. A substantial benefit of such a feature is that the mast may be extended to a sufficient length and height of the top thereof above the base to be suitable for cargo loading and underloading, but may be reduced in length to be easily manhandled by one person. The mast may include an outer elongate member mountable to the base, and an inner elongate member which is telescopically slidable inside the outer member. Drive means may be provided for telescoping the mast. The drive means may include a worm gear extending along the mast. A lower end of the mast may include a drive coupling for coupling the worm gear to a drive mechanism located on the base. The drive mechanism may include at least one gear box and a drive source, the drive source, for example, being provided by a manually operable crank handle. Alternatively, the drive means may be fluid operated, such as from a pneumatic, hydraulic or vacuum drive source. In the case of a trailer application, such a source may be provided, e.g. from a generator on a tractor or cab unit adjacent the base.

Another advantage of the mast being telescopically extendable and retractable is that the mast may be extended to a first height for loading cargo onto the base, and then may be retracted to a second lower height in which the cover of the storage means is closer to the base and therefore, overall, the cargo storage system is not so tall as when the mast is in the extended configuration. If the cargo storage system is transported, e.g. by road, with the mast at the second lower height and the cargo storage system correspondingly lowered, the surface area of the cargo storage system may be reduced (compared to its area when set at a higher height), and fuel consumption may be improved.

Preferably, the mast includes, at a top end thereof, at least one pulley (an axis of rotation thereof being perpendicular to the longitudinal direction of the mast), and at least one height adjustment cable is provided with one end thereof adapted for attachment to the storage means and the other end thereof adapted for attachment to the mast or the base. The mast may include two said pulleys mounted substantially perpendicular to one another, or may include one said pulley selectively mountable to the mast in one of two configurations substantially perpendicular to one another. Each pulley may be provided with a guard to prevent the height adjustment cable from disengaging from the pulley. Each pulley may be provided with a castor mechanism to enable rotation of the axis of the pulley about the longitudinal direction of the mast. The mast may include a fairlead through which the cable is adapted to pass between the storage means and the pulley. The mast may include a securement means, such as a cleat, to which the cable may be secured. Therefore, this arrangement is advantageous, since the height adjustment cable may be pulled until the storage means is located adjacent the top of the mast and then cleated to hold the storage means in position, such as for loading cargo onto the base. Then, the height adjustment cable may be uncleated and released, so as to lower the storage means on top of cargo on the base, or simply onto the base to be thereafter folded up and stowed away.

In a number of most preferred embodiments, the support structure includes at least four said masts, the masts being mountable to the base at spaced locations. Preferably, one mast is mountable at each corner of the base. The base may be rectangular, including two relatively long side edges and relatively short front and rear edges, and the support structure may include six masts, one mast being mountable at each corner of the base and one mast being mountable to the base mid-way along each of the relatively side edges thereof.

When a plurality of masts are provided, a drive means may be provided for telescopically extending and retracting the masts, preferably in unison. In a case where each mast contains a worm drive for telescopically extending respective elongate members thereof, each worm gear may be connected through a rod and gear box arrangement to a single drive source, such as a crank handle or electric motor. Likewise, a single pneumatic, hydraulic, vacuum or other fluid source may be employed with a fluid path circuit extending therefrom for actuating the masts in unison.

Preferably, each mast is of aluminium or aluminium alloy. Where the mast consists of telescopically slideable members driven by a worm gear, the slideable members may be aluminium alloy and the worm drive of steel.

The use of aluminium or aluminium alloy is desirable since the mast may be made lightweight enough to be manhandled easily by one person. This is an important benefit since cargo storage systems, such as in semi-trailer operations, are frequently operated by only one person who also tends to be the driver of a tractor unit for transporting the cargo storage system.

The storage means preferably includes a cover which, in a raised configuration thereof, has a flat top surface, the flat top surface having two side edges, each side edge being provided with a series of spaced fastener rings through which a support cable is threaded. The support cable is preferably adapted for location in a generally straight orientation between the tops of two said support masts, the cover being slidable along the support cable in the direction of one or other of the said two support masts. This is highly advantageous since, with the masts in a vertical orientation, when four masts are provided, and two support cables are provided, each between two of the masts, the support cables may be orientated generally parallel to one another and the cover may be slidable therealong to cover a higher or lower proportion of the base, as desired. This is particularly advantageous during loading of cargo, such as rolled sheet steel (frequently about 26 tonnes in a road freight application), which due to its weight is most conveniently loaded on to the base in a vertical downwards direction. It is believed that this is not possible with prior art Tilt-trailers and Tautliners due to the nature of the roof structure thereof.

Preferably, each support cable is fastenable at one end thereof to the height adjustment cable of one of the said masts or may be integral with the said height adjustment cable. Where each support cable is separate from each height adjustment cable, the support cable preferably includes an eye or toggle at each end thereof, each being engageable with a toggle or eye, respectively, at the end of the height adjustment cable of one of the masts. Preferably, a top surface of the cover is rectangular (or square) and four support cables are provided, each being located adjacent an edge of the cover in the raised configuration. In this case, the support cables may be connected together or integral with one another, preferably forming a rectangle or square-shape in the raised configuration, means being provided at corners thereof for connection to respective height adjustment cases. Side surfaces of the cover may be supported by rings on the cover through which the support cable(s) is/are threaded and front and or rear surfaces of the cover may be supported by transverse portions of the support cable(s) lying under the cover.

In the raised configuration, when the cover forms a box-shaped form together with the base, the masts are preferably located outside the box-shaped form. This means that the storage means may be conveniently raised and lowered and otherwise manhandled while located inside the imaginary enclosure provided by the masts at the extremities of the cargo storage system. This configuration can be contrasted with known cargo storage systems in which posts and other super structure framework are located inside any cover thereof.

Preferably, the height adjustment cable and/or support cable are made of rope. They may be of other materials such as steel wire. However, it is considered that rope is advantageous since a cargo haulier/driver will find it easier to tie a knot and mend a rope cable in the short term than a steel wire cable.

According to a second aspect of the present invention there is provided a cargo carrying vehicle having a cargo storage system according to the first aspect of the invention located thereon. The vehicle may, for example, comprise a land, water or air vehicle, such as a road truck (with or without a trailer or semi-trailer), a railway truck, ship or aircraft.

According to a third aspect of the present invention, there is provided a cover for a cargo storage system, the cover having a sheet-like form, the cover comprising a sheet of material, the cover in one configuration thereof having a top surface (preferably flat) and at least one side surface extending down from an edge of the top surface, and a series of fastener attachment means located on the side surface, the fastener attachment means being located at a plurality of different distances below the top surface. Preferably, the cover includes a series of webs or straps integral with the side surface. The series of straps may include a plurality of spaced vertically extending straps integral with the side surface. The fastener attachment means may be located at the vertically extending straps. The side surface may incorporate a series of horizontally extending straps forming a grid pattern with the vertically extending straps. The fastener attachment means may be located on the horizontally extending straps and/or on the vertically extending straps and/or on nodes of the grid pattern on the side surface.

The fastener attachment means may comprise rings or hooks and may be adapted to be engaged by hooks or rings of a fastener attachment to a base of a cargo storage system.

A further aspect of the invention provides a cover for a cargo storage system, the cover having a sheet-like form, the cover comprising a sheet of material, the cover in one configuration having a top surface and at least one side surface extending down from an edge of the top surface, and at least one strap integral with at least one of the top surface and the side surface and extending from one edge to an opposite edge thereof on an outer side of the said surface.

The cover may include four said side surfaces and in the said one configuration may form the top and four sides of a square or oblong box-shaped structure.

Each strap, in the said one configuration may be located on the exterior of the sheet of material. Each strap may be sewn and/or attached by adhesive to the sheet of material.

An upper portion of the sheet of material may be protected by a fly sheet sewn or attached, by adhesive or other fastening means, to the exterior surface of the sheet of material, the webs being located between the sheet of material and the fly sheet.

A further aspect of the invention provides a cover for a cargo storage system, the cover comprising a sheet of material and at least one webbing strap integral with the sheet of material, said webbing strap having at least two free ends which are adapted to tension the cover for engaging the cover against and bearing the cover down upon cargo under the cover for restraining movement of cargo.

According to a sixth aspect of the present invention, there is provided a method of storing cargo, the method comprising:

(a) holding a storage means (e.g. a cover) in a raised configuration above a base for supporting cargo;

(b) loading cargo onto the base; and

(c) lowering the storage means to a lowered position in which the storage means lies over the base.

Preferably, the storage means and base comprise a box-shaped unit in the raised configuration, the storage means comprising a cover, forming the top surface and walls of the unit in the raised configuration.

Preferably, the method includes sliding the cover along a longitudinal direction of the base from the raised configuration to a further raised configuration in which the base has an uncovered portion, and lowering a cargo load vertically onto the uncovered portion.

The method may include lowering the cover into engagement with cargo loaded on the base and tensioning a restraining mean's, e.g. a webbing strap, formed integrally with the cover, so as to engage the storage means under tension against, and preferably to bear down upon, the cargo to restrain movement of the cargo relative to the base.

According to a seventh aspect of the present invention, there is provided a method of transporting cargo including storing the cargo as set out in the sixth aspect of the present invention and then transporting the cargo so stored from a first location to a second location.

The present invention also extends to and envisages any combination of the features of the aspects hereof and preferred features which is not specifically recited herein.

In a further aspect of the invention there is provided a tarpaulin cover which may be held in an oblong box shape by being attached to four extendable/retractable masts which are external to the tarpaulin. One mast may be located on each corner of the tarpaulin. Two further extendable/retractable masts may be provided centrally on each of two sides of the tarpaulin, making a total of six masts. The tarpaulin may be constructed with securing straps running both horizontally and vertically, the straps being attached externally to the tarpaulin. Top and bottom corners of the tarpaulin may be attached to the corner masts by means of securing clips.

Preferred constructions in accordance with the invention may provide systems for loading and unloading cargo with a similar oblong shape to that of conventional Tiltliners, Tautliners and Euroliners. Once the cargo has been loaded, the masts may be retracted to enable the tarpaulin to be lowered towards or onto the cargo and held in place by means of the securing straps. The securing straps may be connected to securing devices fitted at intervals to the underside of a loading platform or base of the system.

Systems in accordance with preferred embodiments of the present invention have the advantage that they remove the need for much of the superstructure of traditional equipment, thus reducing unladen weight. The ability, in some preferred embodiments, to raise and lower the tarpaulin or cover provides greater versatility in the storing, particularly the restraining and covering, of cargo. The ability to lower the height of the system provides an improvement in aerodynamics and can improve fuel consumption, especially when used on road haulage applications and, additionally, the compatibility of the system for use in rail freight is greatly improved. The incorporation of the tarpaulin within the superstructure enables a weight reduction, in comparison with existing designs, thereby allowing for greater and heavier payloads. Furthermore, the superstructure/support structure may be easily dismantled and removed by one person and stowed away, thus providing a flat platform which enables multi-stacking of systems in a similar state, both for storage and transporting purposes.

Systems in accordance with preferred constructions, allow for greater cargo loading and discharging versatility, due to the capability, in preferred embodiments, of the tarpaulin or cover to be moved vertically and horizontally with respect to the loading platform or base during loading and discharging operations. Furthermore, maintenance and replacement of the superstructure/support structure parts may be undertaken without the removal of cargo, if required. When a problem occurs on a conventional Tilt/Taut/Euroliner, such as if a minor accident happens, it is often necessary to remove the cargo entirely and rebuild the superstructure thereof.

In a preferred construction, in order to fully extend the tarpaulin or cover, the masts are extended by means of a winding gear which pulls the tarpaulin upwards into an oblong shape. The tarpaulin is connected to the masts by means of toggles and eyelets or loops. The rear of a trailer with which the system is associated may be secured by means of a zip, fastening clasps or other similar fastening means of the system. The masts may be retracted by means of the winding gear and securing straps may be connected to one or more securing devices which allow the tarpaulin and straps to secure the cargo. The tarpaulin may be disconnected from a front or rear mast in order to slide along a cable which runs through rings attached to the top of the sheet/tarpaulin. The tarpaulin may be removed by disconnecting it from the masts. The tarpaulin and masts may be removed fully from the base/trailer by one person.

The present invention may be carried out in various ways and two embodiments of the cargo storage systems in accordance with the present invention will now be described, by way of example, with reference to the accompanying drawings, in which:

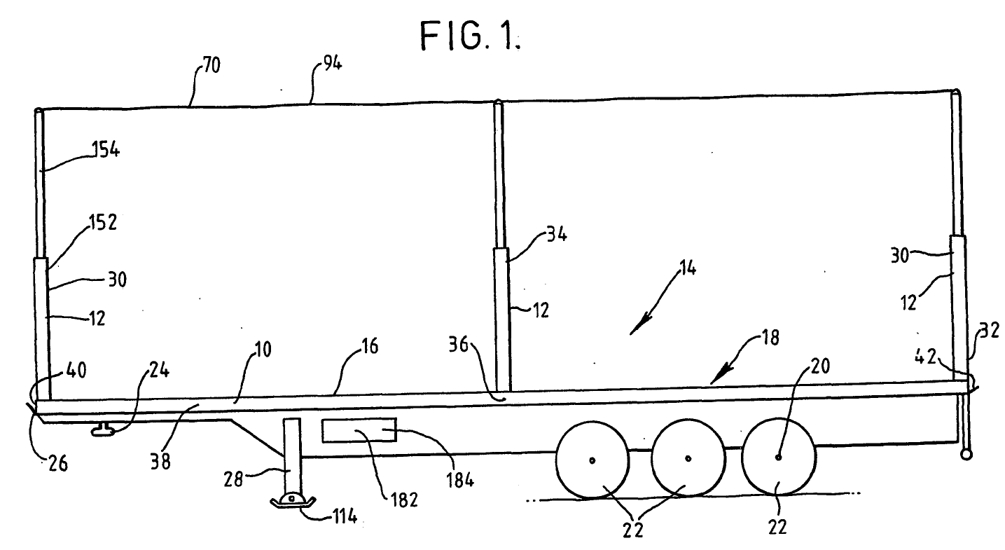

FIG. 1 is a schematic side elevation of part of a preferred embodiment of a cargo storage system in accordance with the present invention;

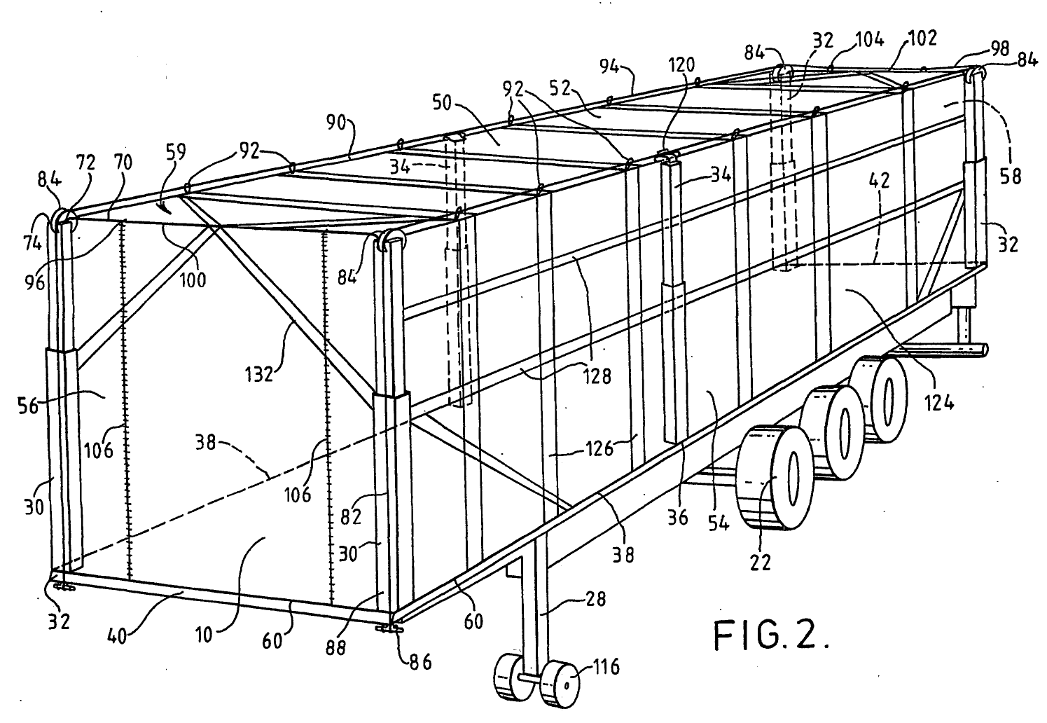

FIG. 2 is a perspective view of the cargo storage system with a cover thereof in a raised configuration;

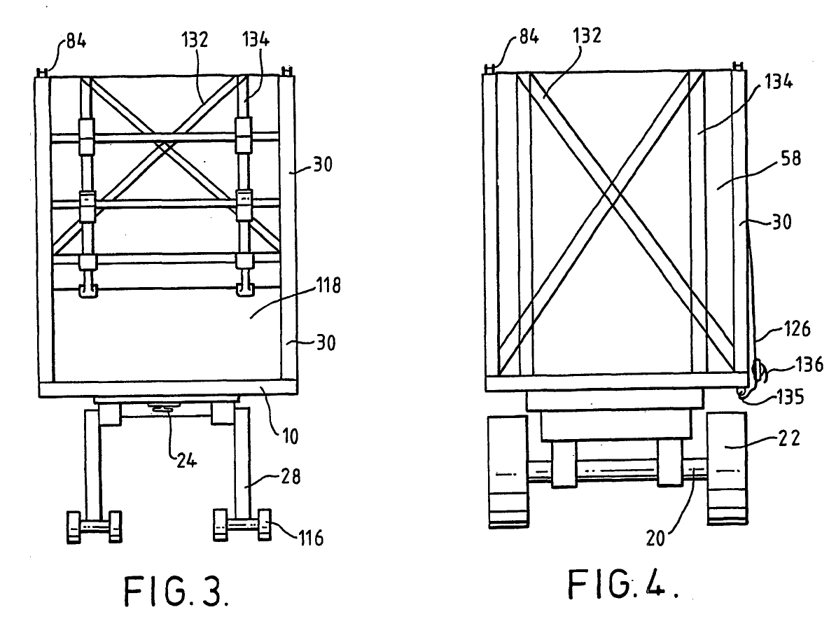

FIG. 3 is a schematic front view of the cargo storage system with the cover in the raised configuration;

FIG. 4 is a schematic rear view of the cargo storage system with the cover in the raised configuration;

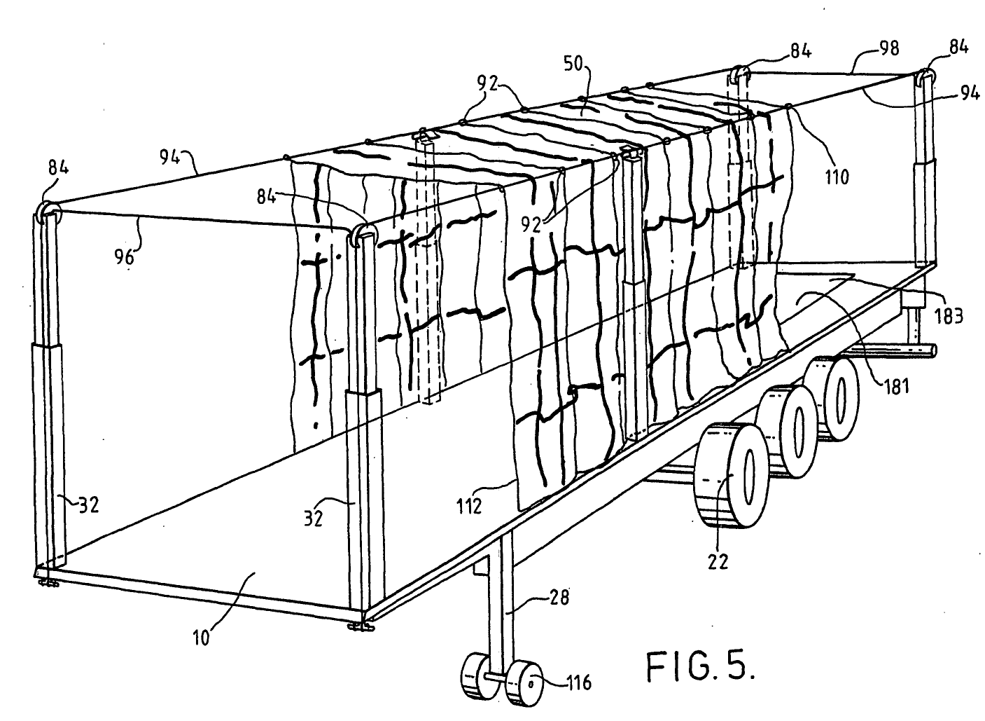

FIG. 5 is a perspective view of the cargo storage system with the cover in a raised, open position;

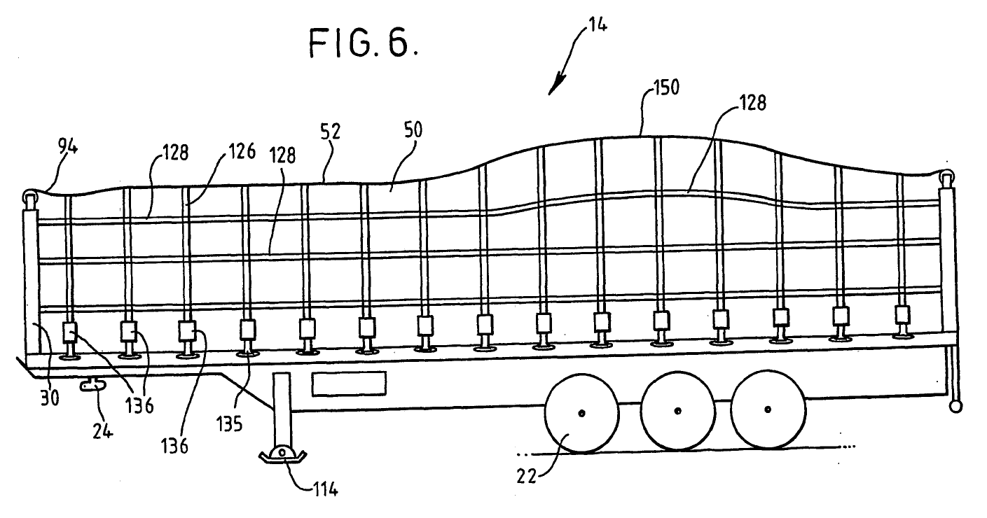

FIG. 6 is a schematic side view of the cargo storage system with the cover in a lowered configuration;

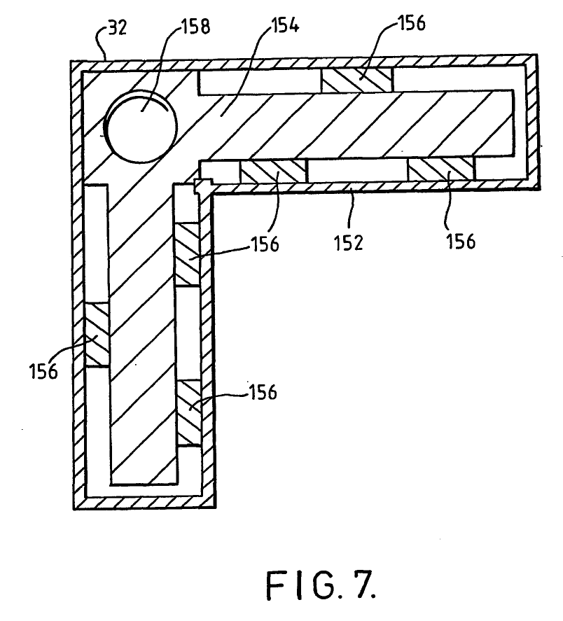

FIG. 7 is a schematic sectional part top plan view of a preferred mast of the cargo storage system;

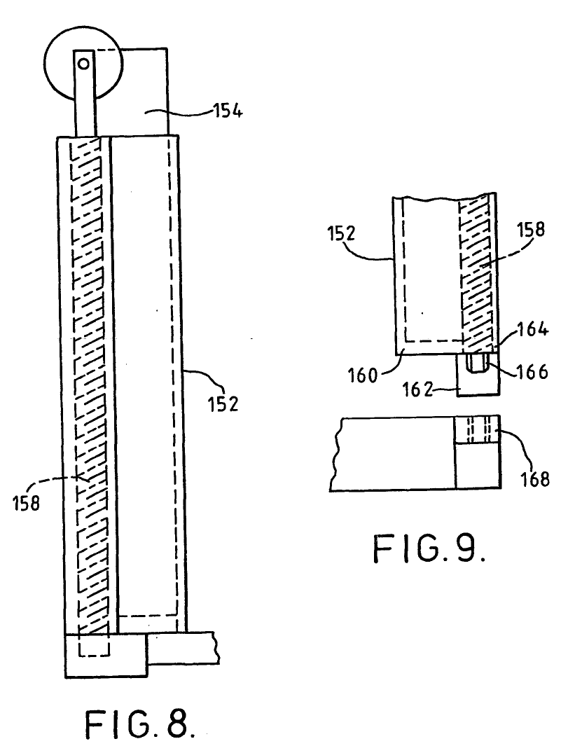

FIG. 8 is a schematic side view of the mast in a retracted orientation, connected to a preferred base of the cargo storage system;

FIG. 9 is a part side view of part of the mast, disconnected from the base;

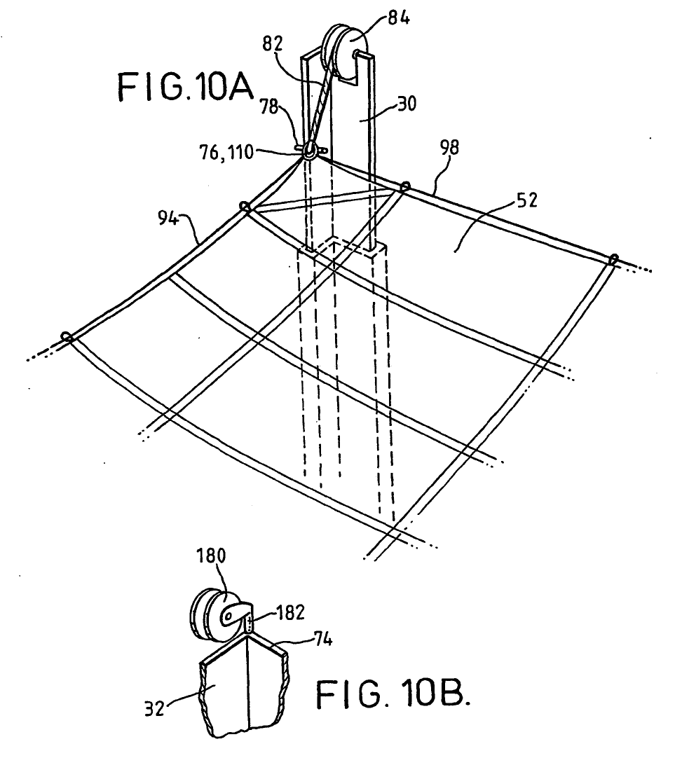

FIG. 10A is a perspective view of a corner of the cover, attached to the mast, with the mast in an extended configuration;

FIG. 10B shows part of the top of the mast, with a modification thereto;

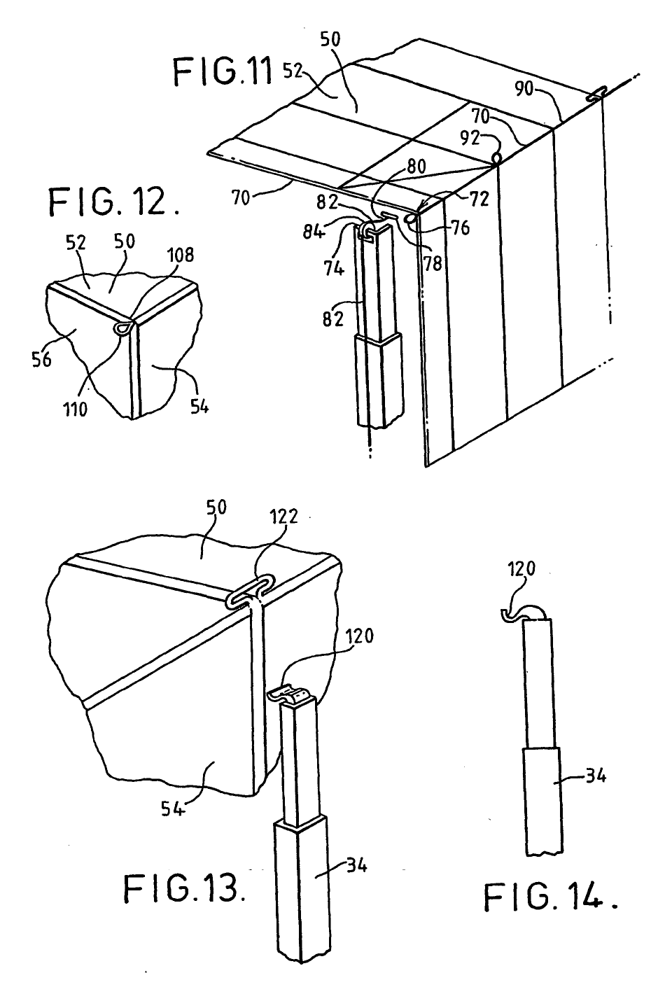

FIG. 11 shows a corner of the cover adjacent a mast of the system, with the mast in an extended configuration thereof;

FIG. 12 shows a detail of a corner of the cover;

FIG. 13 is a schematic perspective view of a mast of the cargo storage system and part of the cover;

FIG. 14 is a side view of the mast of FIG. 13;

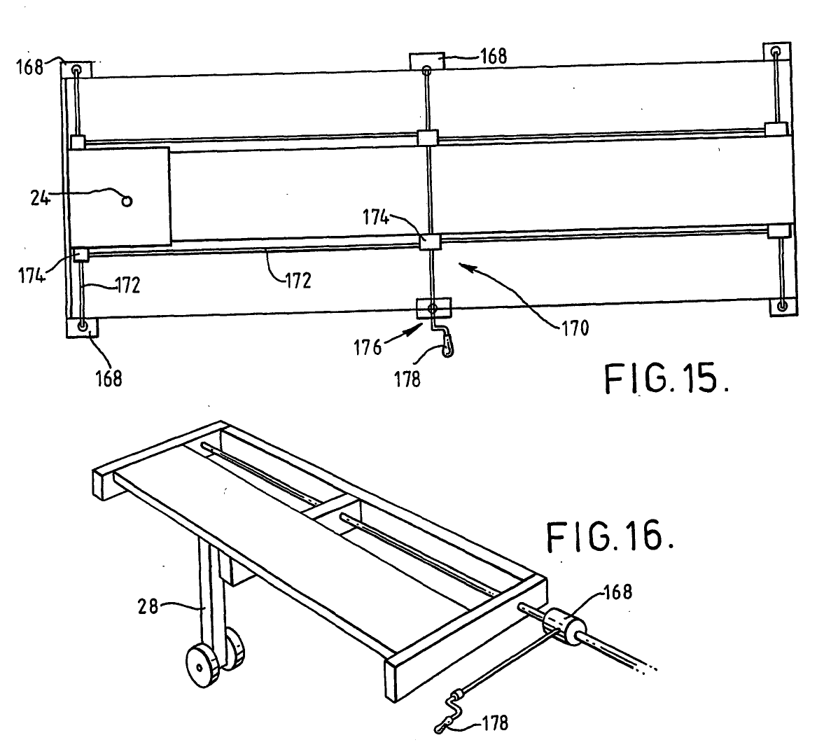

FIG. 15 is a schematic plan view of a drive mechanism for the cargo storage system;

FIG. 16 is a schematic perspective view of part of the drive mechanism of FIG. 15;

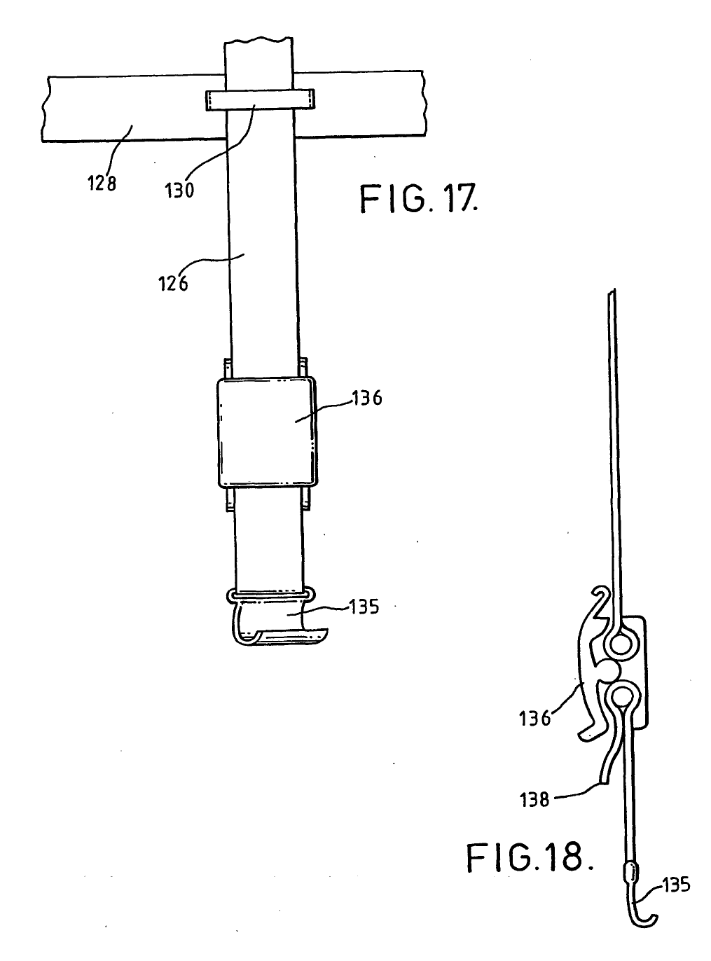

FIG. 17 is a schematic side view of a fastener of the cargo storage system;

FIG. 18 is a front view of the fastener of FIG. 17;

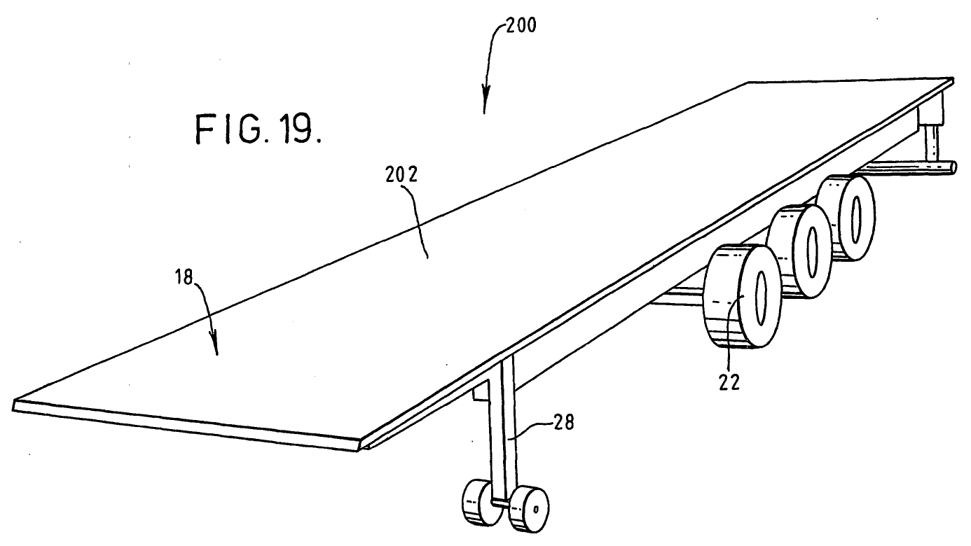

FIG. 19 is a perspective view of a semi-trailer for use with a preferred intermodal cargo storage system in accordance with the present invention;

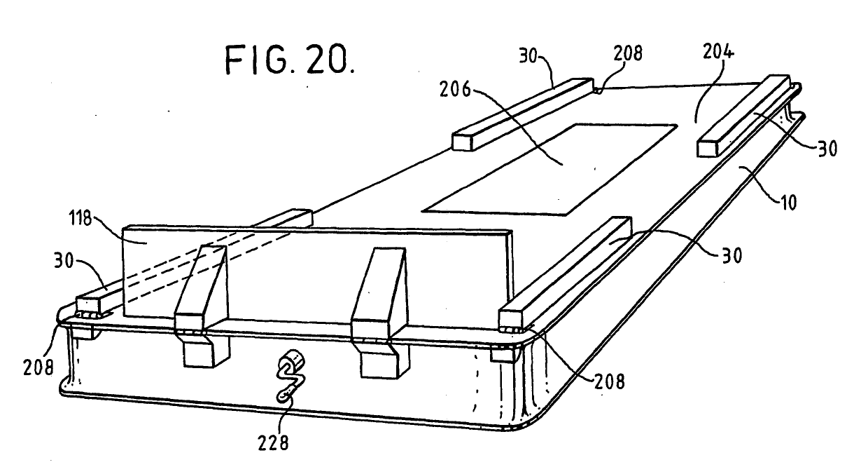

FIG. 20 is a schematic perspective view of a base of the preferred embodiment of an intermodal cargo storage system;

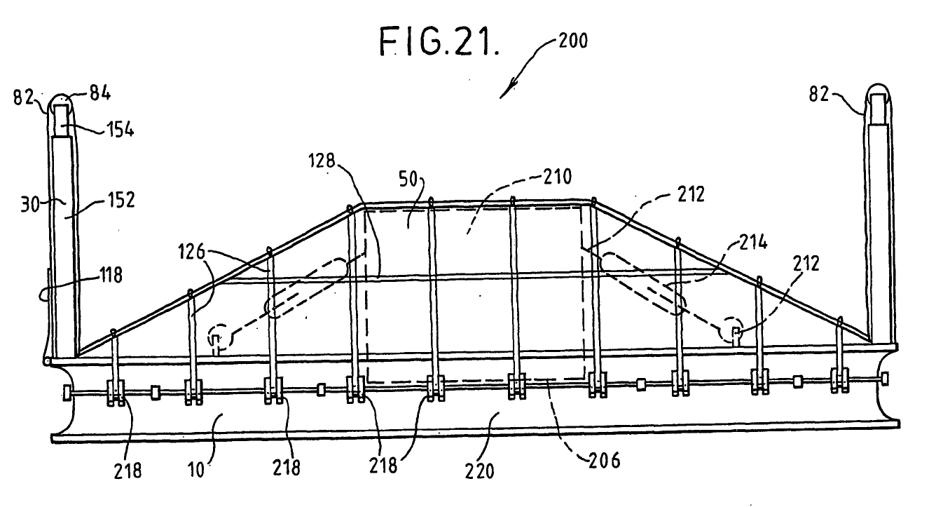

FIG. 21 is a side view of the intermodal cargo storage system;

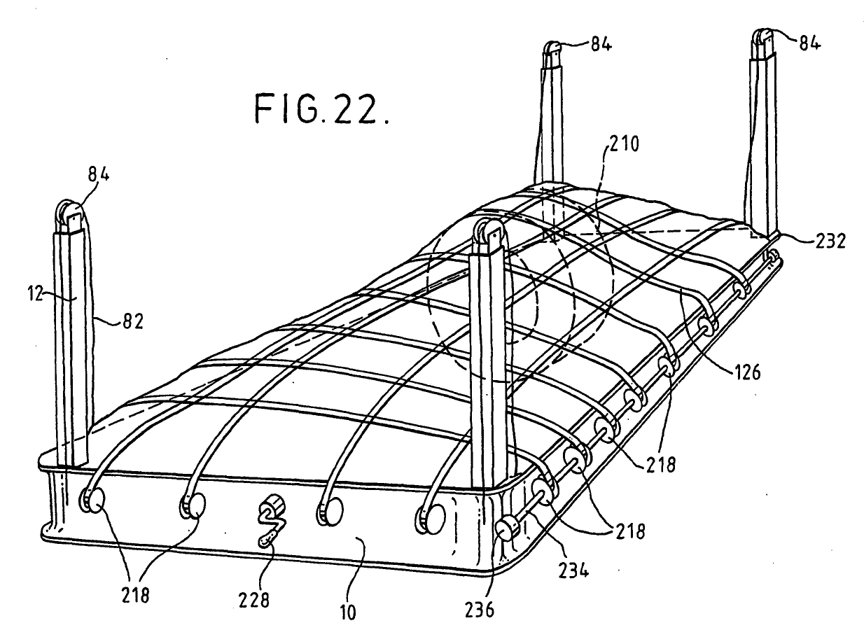

FIG. 22 is a perspective view of the intermodal cargo storage system;

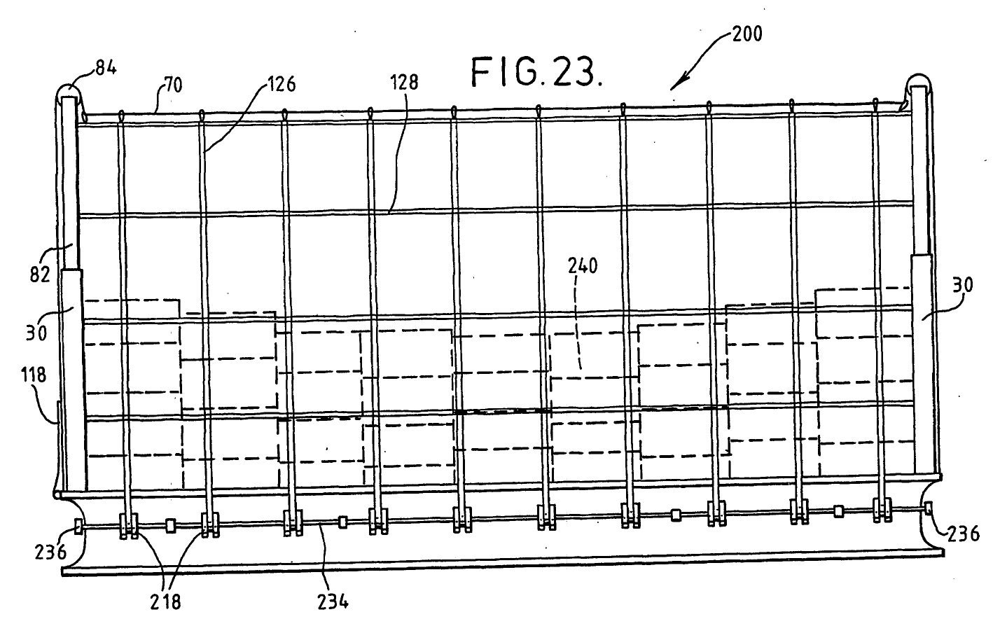

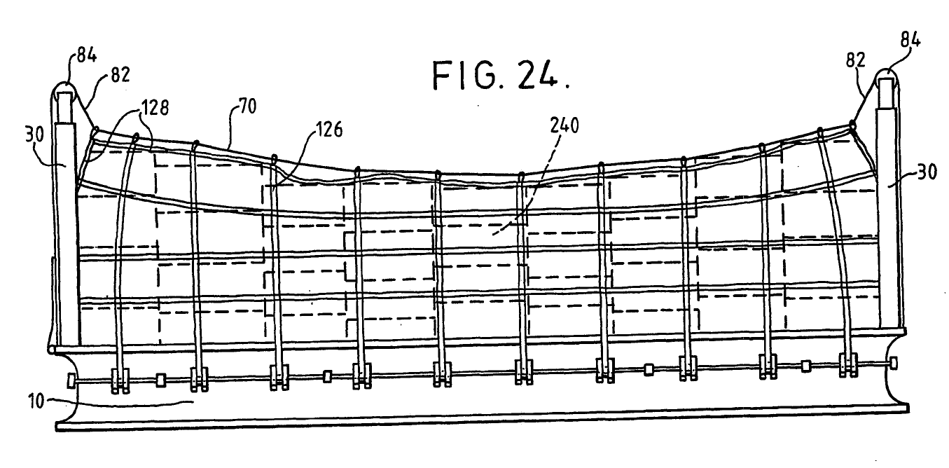

FIG. 23 is a side view of the intermodal cargo storage system, loaded with a different type of cargo, and with a cover thereon in a raised configuration;

FIG. 24 is a schematic side view corresponding to FIG. 23, with masts of the cargo storage system in a retracted configuration thereof;

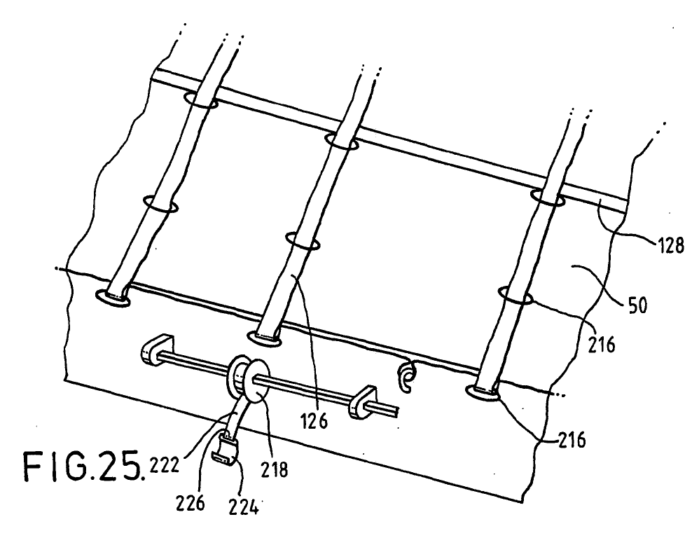

FIG. 25 is a schematic view of part of the intermodal cargo storage system; and

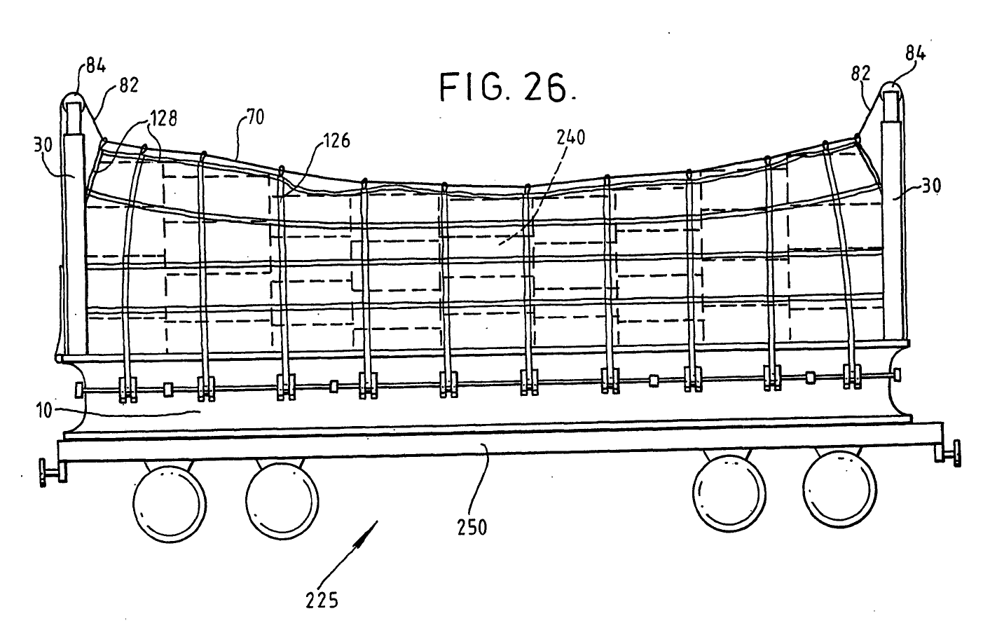

FIG. 26 is a schematic side view of the intermediate cargo storage system, loaded on a railway truck.

FIG. 1 shows a base 10 and support masts 12 of a first preferred embodiment of a cargo storage system 14 in accordance with the present invention. The base 10 comprises a rectangular cargo platform 16 of a road freight semi-trailer 18. The semi-trailer 18 has three axles 20 for respective wheels 22. A fifth-wheel pin 24 is provided near a front end 26 of the base and a telescopic landing leg 28 is provided between the fifth-wheel pin 24 and wheels 22. In a conventional manner the fifth-wheel pin 24 may be attached to a fifth-wheel coupling (not shown) of a road freight tractor/lorry unit (not shown) and the landing leg 28 retracted to enable the semi-trailer 18 to be transported along roads.

In this embodiment, six support masts 12 are provided, four of them comprising corner masts 30, one corner mast 30 being located at each corner of the rectangular base 10. Two of the support masts 12 comprise centre or slave masts 34, each being located at a mid-point 36 of a side edge 38 of the base 10. The side edges 38 are in this embodiment relatively long compared to front 40 and rear 42 edges of the base 10.

The support masts 12 are telescopically extendible and retractable, as will be explained below. The support masts are shown in FIGS. 1 and 2 in extended configurations thereof.

FIG. 2 shows a cover 50 attached to and supported by the support masts 12, the cover 50 being located in a raised position thereof above the base 10. The cover 50 has a tarpaulin-like form and is of flexible and foldable sheet-like material. The cover 50 has a rectangular top surface 52 with the same plan form as the base 10. The cover also has two side surfaces 54, as well as front 56 and rear 58 surfaces. Bottom edges 60 of the side front and rear surfaces 54, 56, 58 are substantially or fully sealed against the base 10, thereby forming an enclosed oblong box 59 between the cover 50 and base 10.

A support cable 70 is held taut in a rectangular configuration, with each corner thereof 72 held to the top 74 of one of the corner masts. The detail of the method of attachment is shown in FIGS. 10A and 11. A loop of rope, e.g. of nylon or kevlar 76 (on or attached to the support cable 70) is securable to a toggle 78 located at one end 80 of a height-adjustment cable 82. The height adjustment cable 82 of each corner mast 30 may be tensioned over a pulley 84 located on the top 74 of the corner mast 30 and may be cleated to a cleat 86 which is located at a lower end 88 of the mast or on the base 10 in the region of the lower end 88 of the mast 32. Each corner mast is so used, with a pulley 84, height adjustment cable 82 and cleat 86 to support the support cable 70 tightly in a rectangular configuration between the tops 74 of the corner masts 30.

The cover 50 has two elongate side edges 90 (FIG. 2) defining the joint between the top surface 52 thereof and side surfaces 54 thereof. The cover 50 is provided with a series of mutually spaced support rings 92 located on the elongate side edges 90 thereof. The rectangular support cable is formed by two relatively long longitudinal cables 94, each longitudinal cable 94 running between two corner masts 30 on one of the two sides of the base 10. The support cable 70 also includes front 96 and rear 98 cables, the front cable joining the two masts at the front edge 40 at base 10, and the rear cable 98 joining the two corner masts 30 at the rear edge 42 of the base 10. The longitudinal cables 94 are threaded through the support rings 92, so that the elongate side edges 90 of the cover 50 hang under and are supported by the longitudinal cables 94. Front 100 and rear 102 top edges of the cover 50 may either hang from support rings 104, as shown for the rear surface 58 of the cover 50 in FIG. 2, or most preferably, the front and rear surfaces 56, of the cover 50 may be simply hung over the front 96 and rear 98 support cables, being supported by direct engagement with the support cables 96, 98 (as shown for the front surface 56 of the cover in FIG. 2). When support rings 104 are provided for the front 100 and/or rear 102 edges of the top surface 52 of the cover 50, they are preferably removably attached to the cable 96, 98 to enable sliding of the rings 92 along the longitudinal cables 94, so that the cover 50 may be slid longitudinally to a position like that in FIG. 5 when the base 10 is only partly covered by the cover 50. This enables cargo to be loaded or unloaded onto or from the base 10 in a generally vertical direction. This is particularly beneficial for some heavy loads, such as raw materials

The front surface 56 of the cover 50 is provided with zips 106 to enable access to the oblong box shaped enclosure (or box 59) formed by the cover 50 in a generally horizontal direction, e.g. for loading palletised goods.

The cover 50 is provided at each of the four corners of 108 of the top surface 52 therefore with a loop 110 which may be attached to a respective toggle 78 of a corner mast 32, along with the loops 76 of the support cable 70, to hold the cover 50 in the rectangular box-like orientation. Further fastening means (not shown) may be provided to attach the various vertical edges 112 of the side, front and rear surfaces 54, 56, 58 of the cover to one another and/or the masts, in order to seal the enclosure 59 formed by the cover 50.

The storage system 14 may be configured with the cover 50 in the elongate box shaped orientation of FIGS. 2, 3 and 4, for loading or unloading cargo (not shown), or for transporting relatively tall cargoes which have sharp portions thereof which are sharp to the extent that it is undesirable for them to contact the material of the cover 50. In such cases, the cargo (not shown) may be secured with ropes (not shown) to attachment points (not shown) on the base 10.

It will be appreciated that the landing leg 28 in FIGS. 1 and 6 is provided with a generally flat bottom support 114 and a minor modification shown in FIGS. 2, 3 and 5 is the use of small support wheels 116, and the two systems may be interchanged.

A headboard 118 (see FIG. 3) may be removably of permanently fitted to the front edge 40 of the base 10, as desired, in which case the front surface 56 of the cover 50 may be secured to the headboard 118 FIG. 3), instead of to the front edge 40 of the base 10 (FIG. 2).

With the cover 50 secured in the configuration of FIG. 2, hooks 120 of the centre masts 34 (FIGS. 13 and 14) may be placed in loops 122 secured to the side edges 90 of the cover 50.

Sewn on to the exterior side 124 of the cover 50 are a series of laterally extending webs 126 which extend up each side surface 54 of a cover and across the top surface 52 thereof. The webs 126 are sewn to the top surface 52 and only upper portions or none of the side surfaces 54. Also sewn on to the side surfaces 54 (and optionally also the top front and rear surfaces 52, 56, 58) are longitudinally extending webs 128 which are sewn to the exterior surface 124 of the cover 50 partly or entirely along the length thereof. As shown in FIG. 17, each laterally extending web 126 may be threaded through a loop 130 as it crosses each longitudinally extending web 126, each loop 130 being fastened to one of the longitudinally extending webs 128. For the purposes of clarity, only some of the webs 126, 128 are shown in the Figures, but in practice, the webs 126, 128 will form a network or grid pattern and will be spaced, preferably at regular intervals, the distance between adjacent lateral webs (and adjacent longitudinal webs) being about 25 centimetres to 1½ metres, about 50 centimetres being the distance, in practice, in the described embodiment.

A number of diagonally extending webs 132 may be provided towards the end of the cover. Again, not all of these webs are shown in all of the drawings, for the purposes of clarity. Vertically extending webs 134 may be provided on the front 56 and rear 58 surfaces of the cover 50 and, again, these are not shown in all of the drawings for the purposes of clarity. The longitudinally extending webs 128 and diagonally extending webs 132 may be secured to the corner masts 30, the base 10 (and/or headboard 118 where fitted) by fastening means (not shown) to tension the cover in the box shaped configuration of FIG. 2. Hooks 135 of a conventional nature may be employed to secure end portions 138 of at least the laterally extending webs 126 to side edges 138 of the base 10 (in a conventional manner) and the laterally extending webs 126 may be tensioned by tensioner devices 136 of a conventional nature, attached to the hooks 135 in a conventional manner.

When a relatively low cargo, such as china clay in bags (not shown) is loaded onto the base 10, while the cover 50, as shown in FIG. 5, has been moved along the support cables 94 (from the FIG. 2 position in which the base is fully covered to the FIG. 5 position in which the base is fully covered), the cover 50 may be lowered, from the box like configuration of FIG. 2, onto the cargo, by retracting the masts (as will be described below) so that the top surface 52 of the cover takes up a position just over or slightly bearing against the cargo. FIG. 6 shows the storage system 14 in this lowered configuration; the cargo (not shown) is under the cover 50 and supporting the cover at a bumped portion 150 thereof. In this configuration, the laterally extending webs 126 have been tensioned down by the tensioning devices 136 or so that the cover 50 bears down upon and holds and restrains the cargo (not shown) in position on the base 10. The longitudinally extending webs 128 are also tensioned. Therefore, the cargo is restrained and covered in this storage position, with the storage system having a relatively low height and surface area, compared to the height and surface area thereof in the oblong box shaped configuration of FIG. 2. This means that in the lowered configuration of FIG. 6, the cargo storage system 14 is capable of passing under lower bridges than when in the configuration of FIG. 2 since it is not so tall. The oblong box shaped configuration of FIG. 2 is substantially the same as that of known Tilt-trailers, Tautliners and Euroliners and, therefore, it will be seen that, in the configuration of FIG. 6, the cargo storage system is substantially shorter in height than the known storage systems. Therefore, shorter routes may be taken under lower bridges than previously possible, and fuel consumption may be substantially improved by the lower surface area and improved aerodynamics of the cargo storage system in the lowered configuration of FIG. 6.

Referring to FIG. 7, each corner mast 32 comprises a lower outer member 152 inside which an inner upper member 154 is telescopically slidable. Rollers or slide blocks 156 are provided between the outer and inner members 152, 154 to enable the telescoping action, with minimal friction. A worm drive 158 (see FIGS. 7 and 8) is provided which, on twisting thereof, causes the elongate extension or retraction of the inner/upper member 154 relative to the lower member 152. As shown in FIG. 9, a lower end 160 of the lower outer member 152 is provided with a foot or projection 162 which plugs into a corresponding bore (not shown) on the base, this engagement holding the mast in the vertical configuration shown in FIGS. 1-6 and 8. A lower end 164 of the worm drive 158 is provided with a coupling 166 which engages in a gear box 168, located in the base 10. Six such gear boxes 168 are provided—one for each mast 12 and, as shown in FIG. 15, the gearboxes are connected by a drive mechanism of rods 172 and further gear boxes 174 to a drive source 176 which in this embodiment comprises a crank handle 178. Although the detail of the centre masts 34 is not shown in the drawings, these are fictionally similar to the corner masts, having telescopically slidable upper and lower members, as well as work drives coupled to the drive mechanism 170. The crank handle 178 may be rotated to extend or retract the support masts in unison. In other embodiments, the drive source may comprise an electric motor. Alternatively, a fluid circuit could be provided for raising and lowering the support masts 12 under pneumatic, hydraulic or other fluid force.

It will be appreciated that, in configuration of FIG. 6, the spare material (not shown) of the cover 50 by which would otherwise hang down below the base 10 may be stowed inside the enclosure form by the cover 50, and the laterally extending webs 126 may be unthreaded through appropriate number of the loops 130 of the longitudinally extending webs 128 for securing the laterally extending webs 128 to the base 10 using the tensioner 136 and hooks 135.

The corner masts 12, e.g. as shown in FIG. 10A, due to the configuration of the pulley 84, are handed (i.e. two versions being mirror images of one another are required) and, to increase the flexibility thereof (so that they are no longer handed) two pulleys (not shown) may be employed, one located as shown in FIG. 10A, and the other located at right angles thereto. Alternatively, as shown in FIG. 10B, a single pulley 180 may be employed which is capable of castoring, by virtue of a vertical castor pivot 182, attached to the top 74 of the corner mast 32, it being appreciated that only a small portion of the mast is shown in FIG. 10B.

Once the cargo (not shown) has been transported or stored in the configuration of FIG. 6, as desired, the cover 50 may be brought back to the configuration of FIG. 2 by untying the various webs 126, 128, 132, 134 and then vertically extending the masts 12. The cover 50 may then be slid along to the configuration of FIG. 5 in which the cargo (as shown) may be unloaded in a vertical direction or generally horizontally, as desired. Then, if desired, the cover 50 may be lowered onto the base 10 by releasing the height adjustment cables 82 (it will be appreciated that some adjustment of the height adjustment cable 82 may be necessary in transforming the system between the box shape configuration of FIG. 2 and the lower configuration of FIG. 6 and vice versa). Then, once the cover 50 is on the base 10, the cover may be simply folded up and stowed in a locker 181 (FIG. 5) having a removable lid 183.

The masts 12 may be fully retracted and placed in a locker 182 having a door 184. Then, if desired, the semi-trailer 18 may be stacked on top of another (not shown) in a similar configuration, and the so stacked arrangement may be transported, e.g. by ship, at relatively low cost.

In an alternative preferred embodiment of a cargo storage system 200 in accordance with the present invention, a semi-trailer 18 for intermodal freight transport may be used for transporting the system 200 (FIG. 19). In this embodiment, in the drawings (FIGS. 19-26), similar components are marked with the same reference numerals as similar components at the embodiment of FIGS. 1-18. The semi-trailer 18 with a rectangular flat upper support surface 202 is adapted to support a cargo base 10 of the system 200 in the form of an intermodal cargo platform 10. The base 10 has the same rectangular platform as the support surface 202 and is provided with a pivotal headboard 118 which is shown in a vertical configuration in FIG. 20 but which may be pivoted to a horizontal configuration for transport/stowage. The base 10 has a flat upper surface 204 incorporating a load well 206. The cargo system 200 of the embodiment of FIGS. 19-25 does not include centre masts 34, but does include four corner masts 30 as in the first embodiment described herein. As shown in FIG. 20, a modification in this embodiment is that the masts 30 are coupled by pivots 208 to the base 10 and, using suitable fastening means (not shown) may be secured either vertically as shown in FIG. 21 or horizontally, as shown in FIG. 20, for stowage. With the headboard 118 pivoted down horizontally, several of the bases 10 may be stacked upon one another and transported in an extremely cost effective manner.

FIG. 21 shows a cargo consisting of a 26-tonne rolled sheet steel cargo 210 which is located in the load well 206. A chain or cable 212 is passed through the centre of the roll of steel 210 and is fastened to D rings 212 on the base 10 and tensioned with bottle-screws 214.

The cargo storage system in FIG. 21 is shown with the cover 50 lowered onto the cargo 210 by retracting the masts 12/releasing the height adjustment cables 82. As FIG. 25 shows, the cover 50 in this embodiment is provided with a series of steel rings 216 fastened to the laterally extending webs 126 at different spaced heights or positions therealong. A series of ratchet drums 218 are located along the length of side surfaces 220 on either side of the base 10. Each ratchet drum 218 is adapted to reel in a cord 222 having a hook 224 located on one end 226 thereof. Each hook 224 may be engaged with a suitable one of the steel rings 216 of each laterally extending web 126 and then turned to tension the webs 126 so that the cover 50 is over the base 10 and bears against and down upon the cargo 210 in order to restrain movement of the cargo 210 and cover the same.

The masts may be kept in the vertical configuration shown in FIG. 21 during storage and/or transport of the base 10, or may be folded down to the horizontal configuration shown in FIG. 20. Therefore, the cargo storage system may have minimum height and this may be particularly advantageous when the base 10 is being transported by rail. It will be appreciated that the base 10 either unloaded (see FIG. 20) or loaded (see FIG. 21) may be transferred, as desired, between the road trailer 18 (see FIG. 19) or a railway truck 252 (FIG. 26) or other vehicle (not shown).

It will be appreciated from the perspective view of FIG. 22 the embodiment of FIG. 22 has a slightly different drive mechanism 170 to that in FIG. 15. In FIG. 22 (in which the headboard 118 has been removed for the purposes of clarity), the crank handle 228 is located at the front of base 10 and the four masts 12 are connected by a drive mechanism (not shown) and various rods/gear boxes (not shown) to the drive handle 228.

Also, as shown in FIG. 22, the longitudinally extending webs 128 may be attached to ratchet drums 218 located at the front and rear 230, 232 of the base 10. The ratchet drums 218 may be rotatably operable to tension the cover 50 individually and/or by means of a drive rod 234 extending along through a plurality of said ratchet drums 218, the drive rod being operable by rotation of a formation 236 at one or each end 237 thereof.

FIG. 23 shows a load of china clay cargo sacks 240 just after having been loaded into the cargo storage system 200, with the cargo storage system in a configuration in which the masts 30 are fully extended and in which the cover has been slid back (from a position partly covering the base 10 for loading) into an oblong box shape above the cargo 240.

FIG. 24 shows the same cargo system 200, but with the masts 30 retracted, and with the height adjustment cables 82 slackened slightly to enable the laterally extending webs 126 and longitudinally extending webs 128 to be secured and tensioned to the base 10 so that the cover 50 is over, bears down against and engages the cargo 240, to prevent movement thereof relative to the base 10.

FIG. 26 shows the cargo storage system of FIG. 24, with the base 10 therefore loaded on to the flat bed 250 of a railway truck 252.

The superstructure of a conventional Tilt-trailer, Taut-liner of Eurotrailers is believed normally to weigh about 1.5 to 2 tonnes. The support structure and storage means of this invention may, for the same size application, weigh a few hundred kilograms, with the cover weighing about 200 kg or about 250 kg (for an oblong box-shaped cover which is 2.7 metres high, 2.55 metres wide and 13.8 metres long) so that it can be manhandled by one man.

The reduction in weight also has the advantage that less transport tax may be payable; in 1999, in Britain, the road tax for a 40 tonne unit is about £5,000, whereas the road tax for a 38 tonne unit is about £3,500.

An advantage of the masts being of aluminium is that one person may be able to life and manhandle them, whereas this may not be possible with structures of similar size of steel.

Preferably, the base (or trailer associated with the base) has one or more lockers below the base at the rear thereof, and the storage system (or cover) and support structure (or masts and cables) may be stowed away therein, for example, through a hatch in a top surface of the base which may comprise a flat bed.

In some applications, e.g. intermodal applications, the masts may be hinged and may lift up slightly, e.g. off winding gear, to a position from which they may be hinged downwardly into a recess, e.g. of the base. Such a hinging function may be provided by pins of the posts slidable in slots of flanges fixed to the base, or vice versa; this, in some preferred embodiments, enables five or more systems to be stacked one on top of the other for railway transport.

The base in the embodiments described is preferably about 13.8 metres long and 2.55 metres wide. Each mast, when in a fully extended configuration thereof, may be about 2.7 metres high, or slightly taller. When retracted, each mast may be about 1.5 metres (5 feet) high; this length enables the mast to be easily manhandled, e.g. for stowage. Preferably, when the mast is in a fully extended configuration and, in a case where the mast is telescopic, comprising upper and lower elongate members thereof, the overlap between the two members is about 45 cm (18 inches), e.g. the overlap of a worm drive operatively connecting the two members.

To ensure that the cover is waterproof, the straps or webs may be sewn thereon and then glued for further adhesion and sealing thereof.

1. A cargo storage system comprising a base for supporting cargo, storage means for storing cargo on the base, and a support structure for the storage means, the support structure being adapted to support the storage means in a raised position thereof above the base and to lower the storage means down from the raised position to a lowered position in which the storage means lies over the base.

2. A cargo storage system as claimed in claim 1 in which the base includes a generally flat, horizontal upper surface.

3. A cargo storage system as claimed in claim 2 in which the base includes a headboard, locatable at the front of the main body with a generally vertical and laterally extending surface thereof located across and above a front edge of the main body.

4. A cargo storage system as claimed in any preceding claim in which the base is approximately 13.8 metres long and approximately 2.55 metres wide.

5. A cargo storage system as claimed in claim 2 or claim 3 or claim 4 in which the upper surface of the base includes a load well, and which in a removable lid for the well is provided, the lid being locatable with an upper surface thereof generally flush with the upper surface of the base of the cargo storage system.

6. A cargo storage system as claimed in any preceding claim in which the base comprises a cargo platform of a vehicle.

7. A cargo storage system as claimed in any one of claims 1-5 in which the base comprises an intermodal cargo base or platform, the intermodal cargo base or platform being transferable between railway and road vehicles, the base including a generally flat bottom support surface, the flat bottom support surface being adapted to be supported on a cargo area of a railway, road or other vehicle.

8. A cargo storage system as claimed in any preceding claim in which, in a stowed configuration of the cargo storage system, the system is stackable, one on top of the other, with a plurality of similar systems.

9. A cargo storage system as claimed in any one of claims 1-8 in which the storage means includes restraining means, the restraining means being adapted to engage the storage means against cargo located on the base and to be tensioned against and/or bear down upon the cargo to restrain movement of the cargo on the base.

10. A cargo storage system as claimed in claim 9 in which the restraining means comprises at least one elongate flexible member, such as a web or strap, which is securable over cargo on the base.

11. A cargo storage system as claimed in any preceding claim in which the storage means has a sheet-like form and consists of a cover for covering cargo on the base.

12. The cargo storage system as claimed in claim 11 in which the storage means, including the cover, is of flexible material.

13. A cargo storage means as claimed in claim 11 or claim 12 in which the storage means includes restraining means integral with the cover, the restraining means comprising at least one elongate flexible member, such as a web or strap, formed integrally with the cover.

14. A cargo storage system as claimed in any one of claims 11-13 in which the restraining means includes a lateral series of mutually spaced straps, each strap in the lateral series extending across the cover, in a raised configuration thereof, in a lateral direction.

15. A cargo storage system as claimed in claim 14 in which the restraining means includes a longitudinal series of mutually spaced straps, each strap in the longitudinal series extending along the cover, in a raised configuration thereof, in a longitudinal direction.

16. A cargo storage system as claimed in claim 15 in which the cover includes a flat top surface, the top surface being square or rectangular and having two opposite side edges, a front edge and a rear edge, the cover including two side surfaces, the side surfaces extending down from the side edges of the flat top surface.

17. A cargo storage system as claimed in any one of claims 11-16 in which the cover and base form a substantially enclosed box-form enclosure in the raised configuration, with lower edges of at least the side surfaces being located adjacent side edges of the base.

18. A cargo storage system as claimed in any one of the preceding claims in which the storage means comprises a cover for cargo, the cover comprising a sheet of material and in one configuration having a flat top surface and at least one side surface extending down from an edge of the top surface, and in which a series of fastener attachment means are provided, located along the side surface at a plurality of different distances below the top surface, the fastener attachment means being located on the vertically extending webs of the side surface.

19. A cargo storage system as claimed in claim 18 in which the side surface includes a series of horizontally extending webs forming a grid pattern with the vertically extending webs, the fastener attachment means being located on said webs, and at least some of the fastener attachment means being located at nodes of the grid pattern on the side surface.

20. A cargo storage system as claimed in claim 18 or claim 19 in which the fastener attachment means comprise rings or hooks which are adapted to be engaged by hooks or rings of a securement means of a base of the cargo storage system.

21. A cargo storage system as claimed in any one of claims 18-20 in which the cover includes four said side surfaces, the cover in the said one configuration forming the top and four sides of a square or oblong box-shaped structure.

22. A cargo storage system as claimed in any one of claims 18-21 in which, in the said one configuration, the webs are located on the exterior of the sheet of material.

23. A cargo storage system as claimed in any one of claims 19-22 in which the webs are sewn and/or attached by adhesive to the sheet of material.

24. A cargo storage system as claimed in any one of claims 18-23 in which an upper portion of the sheet of material is protected by a fly sheet, sewn or attached by adhesive or other fastening means thereto, and located on the exterior side of the sheet of material, with the webs being located between the sheet of material and fly sheet.

25. A cargo storage system as claimed in any one of claims 18-24 in which each web includes a series of mutually spaced fasteners thereon, the fasteners comprising rings fastened to the web at mutually spaced intervals along the length thereof, the base including a series of hooks, each web having one ring thereof engaged by one said hook, each hook being secured to the base by a cord, the cord being tensionable by a ratchet wheel located on the base for tensioning the cover.

26. A cargo storage system as claimed in any one of the preceding claims in which the base includes a locker, and in which the storage means may be folded and placed in the locker for stowage.

27. A cargo storage system as claimed in any preceding claim in which the support structure includes at least one mast which, in one configuration of the system, is located on the base with one end thereof higher than the base, the mast, in the said one configuration, being in a generally vertical orientation.

28. A cargo storage system as claimed in claim 27 in which the mast is removably or pivotally mounted on the base and includes a projection or recess at a lower end thereof which is engageable with a corresponding recess or projection of the base, for holding the mast in the generally vertical orientation.

29. A cargo storage system as claimed in claim 26 in which the mast is pivotably mounted, at a lower end thereof, to the base, and is adapted to pivot down from the generally vertical orientation thereof to a stowage position.

30. A cargo storage system as claimed in claim 28 or claim 29 in which the mast is extendible and retractable in length, the mast preferably being telescopically extendible and retractable in length.

31. A cargo storage system as claimed in claim 30 in which the mast, in an extended configuration thereof, is about 2.7 metres long, the mast, in a contracted configuration thereof, being about 1.5 metres long.

32. A cargo storage system as claimed in claim 30 or claim 31 in which the mast includes an outer elongate member mountable to the base, and an inner elongate member which is telescopically slidable inside the outer member.

33. A cargo storage system as claimed in any one of claims 30-32 which includes drive means for telescoping the mast.

34. A cargo storage system as claimed in claim 33 in which the drive means includes a worm gear extending along the mast and which is rotatable for telescoping the mast, the lower end of the mast including a drive coupling for coupling the worm gear to a drive mechanism located on the base.

35. A cargo storage system as claimed in any one of claims 27-34 in which the mast includes, at a top end thereof, at least one pulley, and at least one height adjustment cable is provided with one end thereof adapted for attachment to the storage means and the other end thereof adapted for attachment to the mast or base.

36. A cargo storage system as claimed in any one of claims 27-35 in which the support structure includes at least four said masts, the masts being mountable to the base at spaced locations, at least one mast being mountable to the base at each corner of the base.

37. A cargo storage system as claimed in claim 36 in which a drive means is provided for telescopically extending and retracting the masts in unison.

38. A cargo storage system as claimed in any one of claims 27-37 in which the storage means includes a cover which, in a raised configuration thereof, has a flat top surface, the flat top surface having two side edges, each side edge preferably being provided with a series of spaced fastener rings through which a support cable is threaded.

39. A cargo storage system as claimed in claim 38 when dependent upon claim 36 in which the support cable is adapted for location in a generally straight orientation between the tops of two said support masts, the cover being slidable along the support cable in the direction of one or other of the said two support masts.

40. A cargo storage system as claimed in claim 39 in which at least four masts are provided, one at each corner of the base, and at least two support cables are provided, each of the two support cables extending between two of the masts, the said two support cables being orientated generally parallel to one another, the cover being slidable therealong to cover higher or lower selected proportions of the base.

41. A cargo storage system as claimed in claim 40 or claim 41 in which each support cable is fastenable at one end thereof to the height adjustment cable of one of the said masts, or is integral with the said height adjustment cable.

42. A cargo storage system as claimed in claim 39 or claim 40 or claim 41 in which a top surface of the cover is rectangular (or square) and four said support cables are provided, each being located adjacent an edge of the cover in the raised configuration, the support cables being connected together or integral with one another, and forming a rectangle (or square-shape) in the raised configuration, means being provided at corners thereof for connection to respective height adjustment cables.

43. A cargo storage system as claimed in any one of claims 39-42 in which the side surfaces of the cover are supported by rings on the cover through which the support cable(s) is/are threaded, and in which front and rear surface of the cover are supported by transverse portions of the support cable(s) laying under the cover.

44. A cargo storage system as claimed in claim 36 or any one of claims 3743 when dependent upon claim 36 in which, in the raised configuration, when the cover forms a box-shaped form together with the base, the masts are located outside the box-shaped form.

45. A cargo carrying vehicle having a cargo storage system according to any one of the preceding claims located thereon.

46. A cover for a cargo storage system, the cover having a sheet-like form, the cover comprising a sheet of material, the cover in one configuration thereof having a top surface and at least one side surface extending down from an edge of the top surface, and a series of fastener attachment means located on the side surface, the fastener attachment means being located at a plurality of different distances below the top surface.

47. A cover for a cargo storage system, the cover having a sheet-like form, the cover comprising a sheet of material, the cover in one configuration having a top surface and at least one side surface extending down from an edge of the top surface, and at least one strap integral with at least one of the top surface and the side surface and extending from one edge to an opposite edge thereof on an outer side of the at least one said surface.

48. A cover as claimed in claimed in claim 47 in which, in the said configuration, the strap extends from a bottom edge of the side surface to an upper edge thereof and further extends across the top surface of the cover from the said edge thereof to an opposite edge thereof; and in which the cover preferably includes a second side surface extending down from said opposite edge of the top surface, the strap preferably further extending from the said opposite edge of the top surface down to a bottom edge of the second side surface.

49. A cover as claimed in claim 47 or claim 48 which includes a series of fastener attachment means located on the side surface of the cover, the fastener attachment means, in the said configuration, being located at a plurality of different distances below the top surface.

50. A cover as claimed in any one of claims 46 to 49 in which the cover includes a series of straps integral with the side surface, the straps preferably being on an outer side of the cover.

51. A cover as claimed in claim 50 in which the series of straps include a plurality of spaced vertically extending straps integral with the side surface.

52. A cover as claimed in claim 51 when dependent upon claim 46 or claim 49 in which the fastener attachment means are located at the vertically extending straps.

53. A cover as claimed in claim 52 in which the side surface incorporates a series of horizontally extending straps forming a grid pattern with the vertically extending straps.

54. A cover as claimed in claim 53 in which the fastener attachment means are located on the horizontally extending straps and/or on the vertically extending straps and/or on nodes of the grid pattern of the side surface.

55. A cover as claimed in any one of claims 46 and 49 to 54 in which the fastener attachment means comprises rings or hooks and are adapted to be engaged by hooks or rings of a fastener to a base of a cargo storage system.

56. A cover as claimed in any one of claims 46-55 which includes four said side surfaces and which, in the said one configuration, forms the top and four sides of a square or oblong box-shaped structure.

57. A cover as claimed in any one of claims 46-56 in which the straps, in the said one configuration, are located on the exterior of the sheet of material, the straps being sewn and/or attached by adhesive to the sheet of material.

58. A cover as claimed in any of claims 46-57 in which an upper portion of the sheet of material is protected by a fly sheet sewn and/or attached by adhesive or other fastening means, to the exterior surface of the sheet of material, the webs being located between the sheet of material and fly sheet.

59. A method of storing cargo comprising:
(a) holding a storage means (e.g. a cover) in a raised configuration above a base for supporting cargo;
(b) loading cargo onto the base; and
(c) lowering the storage means to a lowered position in which the storage means lies over the base.

60. A method as claimed in claim 59 in which the storage means and base comprise a box-shaped unit, in a raised configuration thereof, the storage means comprising a cover, forming the top surface and the walls of the unit in the raised configuration.

61. A method as claimed in claim 59 or claim 60 which includes sliding the cover along a longitudinal direction of the base from the raised configuration to a further raised configuration in which the base has an uncovered portion, and lowering a load vertically onto the uncovered portion.

62. A method as claimed in any one of claims 59-61 which includes lowering the cover into engagement with cargo loaded on the base and tensioning a restraining means, e.g. a webbing strap, formed integrally with the cover, so as to engage the storage means under tension against and bearing down upon the cargo to restrain movement of the cargo relative to the base.

63. A method of transporting cargo including storing the cargo as claimed in any one of claims 59-62, and then transporting the cargo, so stored, from a first location to a second location.

64. A tarpaulin cover which may be held in an oblong box-shape by being attached to four extendible/retractable masts which are external to the tarpaulin, one mast preferably being located at each corner of the tarpaulin, the tarpaulin preferably being constructed with securing straps running both horizontally and vertically, the straps being attached externally to the tarpaulin, top and bottom corners of the tarpaulin being attachable to the corner masts by means of securing means such as securing clips.

65. A cargo storage system substantially as described herein with reference to FIGS. 1-18 or 19-26 of the accompanying drawings.

66. A cover for a cargo storage system, the cover being substantially as described herein with reference to FIGS. 1-18 or FIGS. 19-26 of the accompanying drawings.

67. A method of storing cargo substantially as described herein with reference to FIGS. 1-18 or FIGS. 19-26 of the accompanying drawings.

68. A method of transporting cargo substantially as described herein with reference to FIGS. 1-18 or FIGS. 19-26 of the accompanying drawings.

69. A cover for a cargo storage system, the cover comprising a sheet of material and at least one strap integral with the sheet of material, said strap having at least two spaced fastener portions which are adapted to tension the strap for engaging the cover against and bearing down upon cargo under the cover for restraining the cargo.

70. A cover as claimed in claim 69 in which the cover includes, in one configuration, a flat surface having two opposite edges, and in which the strap extends between the two opposite edges on an exterior side of the sheet of material.

71. A cover as claimed in claim 69 or 70 in which the fastener portions comprise ends of the strip.

72. A cover as claimed in claim 69 or claim 70 or claim 71 in which the fastener portions comprise rings or hooks spaced from one another along the strap.
